(19) United States
(12) Patent Application Publication
(10) Pub. No.: US 2015/0061553 A1
(43) Pub. Date: Mar. 5, 2015

(54) APPARATUS AND METHOD FOR DETECTING BACK ELECTRO-MOTIVE FORCE IN SENSORLESS MOTOR

(71) Applicant: SAMSUNG ELECTRO-MECHANICS CO., LTD., Suwon (KR)

(72) Inventor: Soo Woong LEE, Suwon (KR)

(73) Assignee: SAMSUNG ELECTRO-MECHANICS CO., LTD., Suwon (KR)

(21) Appl. No.: 14/084,531

(22) Filed: Nov. 19, 2013

(30) Foreign Application Priority Data
Sep. 3, 2013 (KR) 10-2013-0105612

(51) Int. Cl. H02P 6/18

(52) U.S. Cl. CPC H02P 6/182
USPC 318/400.04

(57) ABSTRACT

There are provided an apparatus and a method for detecting back electro-motive force (EMF) in a motor. The apparatus includes: a mode selecting unit selecting between an amplification mode and a bypass mode when power is on; a back EMF amplifying unit amplifying a back EMF voltage from the motor during an initial driving period if the amplification mode is selected by the mode selecting unit, and allowing the back EMF voltage to bypass it after the initial driving period if the bypass mode is selected by the mode selecting unit; and a zero-crossing detecting unit detecting a zero-crossing of an output signal from the back EMF amplifying unit, wherein the back EMF amplifying unit amplifies the back EMF voltage to a level detectable by the zero-crossing unit or higher.

### CROSS-REFERENCE TO RELATED APPLICATION

This application claims the benefit of Korean Patent Application No. 10-2013-0105612 filed on Sep. 3, 2013, with the Korean Intellectual Property Office, the disclosure of which is incorporated herein by reference.

### BACKGROUND

1. Field of the Invention

The present invention relates to an apparatus and a method for detecting back electro-motive force in a sensorless motor.

2. Description of the Related Art

In general, in order to achieve miniaturization and cost reductions in motor control devices, a sensorless driving scheme is commonly being used so as to reduce the amount of required sensor components, such as a hall sensor and a current sensor.

Typically, in a motor operating in a sensorless driving fashion (sensorless motor), a back electro-motive force (EMF) voltage is used to detect a rotation rate of the motor.

However, such aback EMF voltage is proportional to the rotation rate in a motor, and thus has large variations, according to the rotation rate of the motor.

Therefore, in existing sensorless motors, motors are driven at a low speed during an initial driving period, and thus, a level of a back EMF voltage is too low to be accurately detected.

Patent Document 1 below relates to a circuit for compensating for detection in a motor at a low speed but does not disclose any feature to solve the problem of detecting a back EMF voltage during an initial driving period in a sensorless motor.

### RELATED ART DOCUMENT

(Utility Model Document 1) Korean Utility Model Publication No. 1991-0019071

### SUMMARY

An aspect of the present invention provides an apparatus and a method capable of accurately detecting back electro-motive force (EMF) in a sensorless motor using a back EMF voltage even during an initial driving period by way of performing an amplification mode in which a back electro-motive force (EMF) voltage is amplified during the initial driving period, and performing a bypass mode in which a back EMF voltage bypasses an amplification path during a normal mode after the initial driving period.

According to an aspect of the present invention, there is provided an apparatus for detecting a back EMF in a motor, the apparatus including: a mode selecting unit selecting between an amplification mode and a bypass mode when power is on; a back EMF amplifying unit amplifying a back EMF voltage from the motor during an initial driving time if the amplification mode is selected by the mode selecting unit, and allowing the back EMF voltage to bypass it after the initial driving period if the bypass mode is selected by the mode selecting unit; and a zero-crossing detecting unit detecting a zero-crossing of an output signal from the back EMF amplifying unit, wherein the back EMF amplifying unit amplifies the back EMF voltage to a level detectable by the zero-crossing unit or higher.

The back EMF amplifying unit may amplify the back EMF voltages in three phases input through first, second and third output terminals of a three-phase motor or allow them to bypass it.

The mode selecting unit may generate a mode selection signal including a first mode selection signal having a high level during the initial driving period and having a low level after the initial driving period, and a second mode selection signal inverted from the first mode selection signal.

According to another aspect of the present invention, there is provided an apparatus for detecting back electro-motive force (EMF) in a motor, including: a mode selecting unit providing a mode selection signal for selecting between an amplification mode and a bypass mode when power is on; a back electro-motive force (EMF) amplifying unit amplifying a back EMF voltage from the motor during an initial driving period, and allowing the back EMF voltage to bypass it after the initial driving period according to the mode selection signal; and a zero-crossing detecting unit detecting a zero-crossing of an output signal from the back EMF amplifying unit, wherein the back EMF amplifying unit amplifies the back EMF voltage to a level detectable by the zero-crossing unit or higher during the initial driving period with a gradually decreasing amplification gain.

The mode selection signal may include first and second mode selection signal, and the mode selecting unit may include: a mode-selection-signal generating unit generating the first mode selection signal having a high level during the initial driving period and having a low level after the initial driving period, and an inverter inverting the first mode selection signal to provide the second mode selection signal.

The mode-selection-signal generating unit may include a power-on-reset (POR) circuit unit generating a POR signal for resetting an internal register using the first mode selection signal when power is on.

According to another aspect of the present invention, there is provided an apparatus for detecting back electro-motive force (EMF) in a motor, the apparatus including: a mode selecting unit providing a mode selection signal including a first mode selection signal having a high level during an initial driving period and having a low level after the initial driving period, and a second mode selection signal inverted from the first mode selection signal; a back EMF amplifying unit amplifying a back EMF voltage from the motor during the initial driving period according to the first and second mode selection signals, and allowing the back EMF voltage to bypass it after the initial driving period according to the first and second mode selection signals; and a zero-crossing detecting unit detecting a zero-crossing of an output signal from the back EMF amplifying unit, wherein the mode selecting unit generates the first mode selection signal using a power-on-reset (POR) signal for resetting an internal register when power is on and wherein the back EMF amplifying unit amplifies the back EMF voltage to a level detectable by the zero-crossing unit or higher.

The back EMF amplifying unit may include: an amplification-path circuit unit completed during the initial driving period to amplify the back EMF voltage from the motor; and a bypass-path circuit unit completed after the initial driving period to allow the back EMF voltage from the motor to bypass the amplification-path circuit unit.

The amplification-path circuit unit may include at least one switch and an amplifier connected between an input node and an output node of the back EMF amplifier, wherein the at least one switch is switched on during the initial driving period.

The amplification-path circuit unit may include a bypass switch connected between an input node and an output node of the back EMF amplifier and the switch is switched on after the initial driving period.

According to another aspect of the present invention, there is provided a method for detecting back electro-motive force (EMF) in a motor, the method including: determining, by a mode selecting unit, whether an initial driving period has elapsed when power is on; amplifying, by a back EMF amplifying unit, a back EMF voltage from the motor if it is determined that the initial driving period has not elapsed; allowing, by the back EMF amplifying unit, the back EMF voltage to bypass it if it is determined that the initial driving period has elapsed; and detecting a zero-crossing of the amplified EMF voltage or the bypassing EMF voltage, wherein the back EMF amplifying unit amplifies the EMF voltage to a level detectable by a zero-crossing detecting unit or higher.

According to another aspect of the present invention, there is provided a method for detecting back electro-motive force (EMF) in a motor, the method including: determining, by a mode selecting unit, whether an initial driving period has elapsed when power is on, to thereby generate a mode selection signal including a first mode selection signal having a high level and a second mode selection signal having a low level if the initial driving period has not elapsed, and to generate the mode selection signal having the first mode selection signal having a low level and the second mode selection signal having a high level after the initial driving period; amplifying, by a back EMF amplifying unit, a back EMF voltage from the motor according to the first and second mode selection signals if it is determined that the initial driving period has not elapsed; allowing, by the back EMF amplifying unit, the back EMF voltage to bypass it according to the first and second mode selection signals if it is determined that the initial driving period has elapsed; and detecting a zero-crossing of the amplified EMF voltage or the bypassing EMF voltage, wherein the back EMF amplifying unit amplifies the EMF voltage to a level detectable by a zero-crossing detecting unit or higher during the initial driving period with a gradually decreasing amplification gain.

The amplifying of the back EMF voltage may include amplifying the back EMF voltage from the motor by an amplification-path circuit unit of the back EMF amplifying unit, the amplification-path circuit unit being completed during the initial driving period.

The allowing of the back EMF voltage to bypass may include allowing the back EMF voltage from the motor to bypass it through a bypass-path circuit unit of the back EMF amplifying unit, the bypass-path circuit unit being completed after the initial driving period.

### BRIEF DESCRIPTION OF DRAWINGS

The above and other aspects, features and other advantages of the present invention will be more clearly understood from the following detailed description taken in conjunction with the accompanying drawings, in which:

FIG. 1 is a block diagram of an apparatus for detecting back electro-motive force (EMF) in a sensorless motor according to an embodiment of the present invention;

FIG. 2 is a block diagram of the apparatus for detecting a back EMF in a sensorless three-phase motor according to the embodiment of the present invention;

FIG. 3 is a diagram illustrating the mode selecting unit 100 according to the embodiment of the present invention;

FIG. 4 is a detailed diagram of the back EMF amplifying unit and the zero-crossing detecting unit according to the embodiment of the invention;

FIG. 5 is a diagram showing an implementation of the back EMF amplifying unit according to the embodiment of the present invention;

FIG. 6 is a diagram showing another implementation of the back EMF amplifying unit according to the embodiment of the present invention;

FIG. 7 is a diagram illustrating the operation of the amplifying mode according to the embodiment of the present invention;

FIG. 8 is a diagram illustrating the operation of the bypass mode according to the embodiment of the present invention;

FIG. 9 is a first timing chart of principal voltages and signals according to the embodiment of the present invention;

FIG. 10 is a second timing chart of principal voltages and signals according to the embodiment of the present invention; and

FIG. 11 is a flowchart illustrating a method for detecting a back EMF in a sensorless motor according to an embodiment of the present invention.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

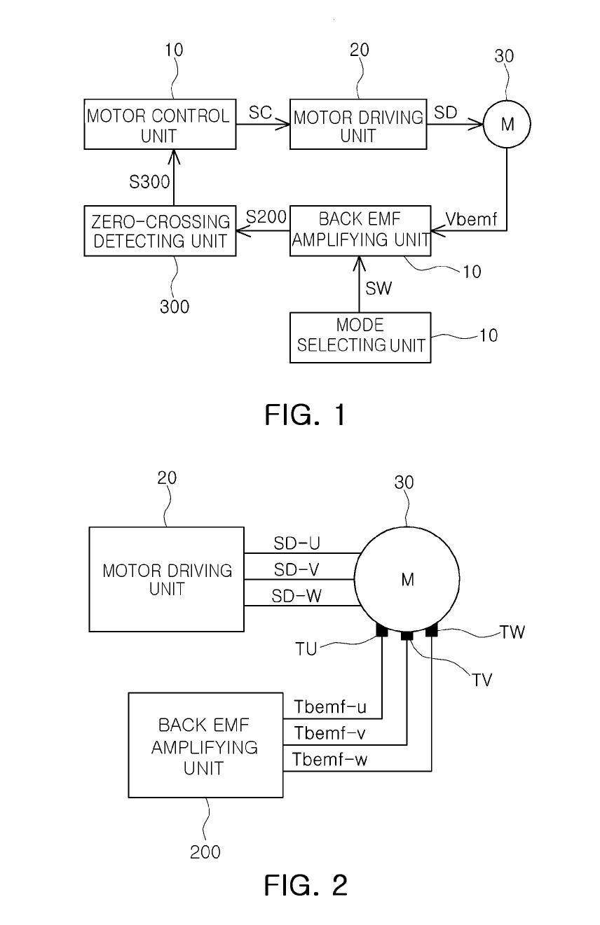

FIG. 1 is a block diagram of an apparatus for detecting back electro-motive force (EMF) of a sensorless motor according to an embodiment of the present invention.

Referring to FIG. 1, the sensorless motor apparatus to which the embodiment of the present invention is applied may include a motor control unit 10, a motor driving unit 20 and a motor 30.

The motor control unit 10 may provide a control signal SC to the motor driving unit 20 for driving the motor 30.

The motor driving unit 20 may provide a motor driving signal SD to the motor 30 according to the control signal SC from the motor control unit 10.

Then, the motor 30 may operate according to the driving signal SD from the motor driving unit 20.

The apparatus for detecting a back EMF according to the embodiment of the present invention, which may be applied to the sensorless motor apparatus, may include a mode selecting unit 100, a back electro-motive force amplifying unit 200, and a zero-crossing detecting unit 300.

The mode selecting unit 100 may select between an amplification mode and a bypass mode based on an initial driving period T1 when power is on.

For example, the amplification mode may be selected during the initial driving period T1 and the bypass mode may be selected after the initial driving period T1.

If the amplification mode is selected by the mode selecting unit 100, the back EMF amplifying unit 200 may amplify a back EMF voltage V_{bemf} from the motor during the initial driving period T1 to provide it to the zero-crossing detecting unit 300. Here, the back EMF amplifying unit 200 may amplify the back EMF voltage V_{bemf} to a level detectable by the zero-crossing detecting unit 300 or higher.

For example, the back EMF amplifying unit 200 may amplify the back EMF voltage V_{bemf} with a constant gain or with a gradually decreasing gain. If the back EMF amplifying unit 200 includes a variable-gain amplifier, it may amplify the back EMF voltage V_{bemf} with a gradually decreasing gain.

Further, if the bypass mode is selected by the mode selecting unit 100, the back EMF amplifying unit 200 may allow the back EMF voltage V_{bemf} to bypass it toward the zero-crossing detecting unit 300 after the initial driving period T1.

The zero-crossing detecting unit 300 may detect a zero-crossing from an output signal S200 from the back EMF amplifying unit 200.

For example, the zero-crossing detecting unit 300 may determine whether there is a zero-crossing based on a level of the output signal S200 from the back EMF amplifying unit 200, to provide the motor control unit 10 with a signal in the form of a pulse.

FIG. 2 is a block diagram of the apparatus for detecting a back EMF in a sensorless three-phase motor according to the embodiment of the present invention. Referring to FIG. 2, the motor driving unit 20 provides the three-phase motor 30 with driving signals in three phases SD-U, SD-V and SD-W, to drive the three-phase motor 30.

Here, the back EMF amplifying unit 200 may amplify back EMF voltages V_{bemf}-u, V_{bemf}-v and V_{bemf}-w in three phases input through the first to third output terminals TU, TV and TW of the three-phase motor 30, respectively, or may allow them to bypass it.

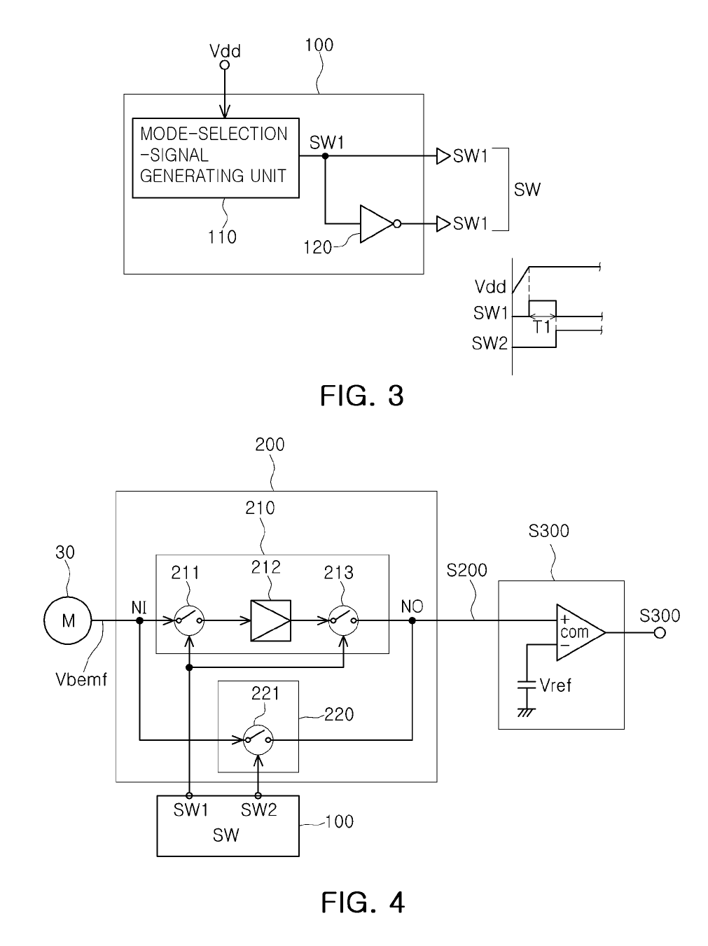

FIG. 3 is a diagram illustrating the mode selecting unit 100 according to the embodiment of the present invention.

Referring to FIG. 3, the mode selecting unit 100 may generate a mode selection signal SW including a first mode selection signal SW1 having a high level during the initial driving period T1 and having a low level after the initial driving period T1, and a second mode selection signal SW2 inverted from the first mode selection signal SW1.

As an exemplary implementation, the mode selecting unit 100 may include a mode-selection-signal generating unit 110 and an inverter 120.

The mode-selection-signal generating unit 110 may generate the first mode selection signal SW1 having a high level during the initial driving period T1 and having a low level after the initial driving period T1.

For example, the mode selecting unit 100 may include a power-on-reset (POR) circuit unit, which provides a power-on-reset (POR) signal for resetting an internal register when power is on. The mode selecting unit 100 may generate the first mode selection signal SW1 using the POR signal. By using the POR circuit unit, it is not necessary to design a separate circuit to thereby simplify the design and reduce the manufacturing cost.

The inverter 120 may invert the first mode selection signal SW1 to provide the second mode selection signal SW2.

FIG. 4 is a detailed diagram of the back EMF amplifying unit and the zero-crossing detecting unit according to the embodiment of the invention.

Referring to FIG. 4, the back EMF amplifying unit 200 may include an amplification-path circuit part 210 and a bypass-path circuit part 220.

The amplification-path circuit part 210 may be completed during the initial driving period T1 to amplify a back EMF voltage from the motor.

The bypass-path circuit part 220 may be completed after the initial driving period T1 to allow a back EMF voltage from the motor to flow therethrough.

As an exemplary implementation, as shown in FIG. 4, the amplification-path circuit part 210 may include a first switch 211, an amplifier 212 and a second switch 213 between an input node NI and an output node NO.

The first and second switches 211 and 213 may be switched on during the initial driving period T1. At this time, the amplifier 212 becomes operable, so that it may amplify a back EMF voltage from the motor.

Here, at least one of the first and second switches 211 and 213 maybe included between the input node NI and the output node NO of the back EMF amplifying unit 200.

Further, the bypass-path circuit part 220 may include a bypass switch 221 connected between the input node NI and the output node NO of the back EMF amplifying unit 200.

The bypass switch 221 may be switched on after the initial driving period T1, to allow a back EMF voltage from the motor to flow through the bypass-path circuit part 220.

Further, the zero-crossing detecting unit 300 may include a comparator COM that has a non-inverted input terminal to receive the output signal S200 from the back EMF amplifying unit 200, an inverted input terminal to receive a reference voltage Vref, and an output terminal.

The comparator COM may output a high-level signal to the output terminal if the output signal S200 is higher than the reference voltage Vref and may output a low-level signal to the output terminal if the output signal S200 is not higher than the reference voltage Vref.

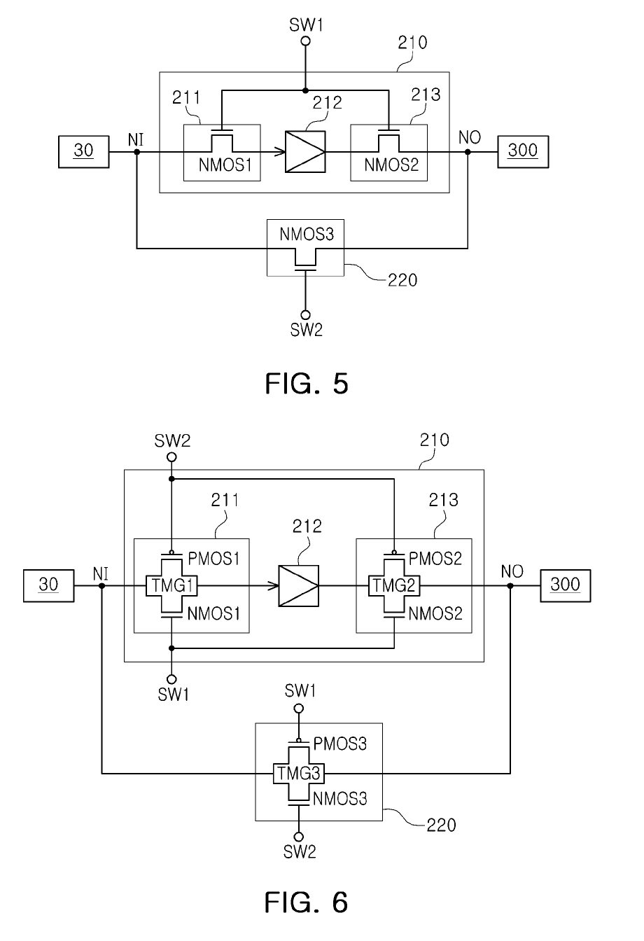

FIG. 5 is a diagram showing an implementation of the back EMF amplifying unit according to the embodiment of the present invention.

Referring to FIG. 5, the first and second switches 211 and 213 of the amplification-path circuit part 210 may be made up of first and second NMOS transistors NMOS1 and NMOS2, respectively.

In addition, the bypass switch 221 of the amplification-path circuit part 210 may be made up of a third NMOS transistor NMOS3.

The first and second NMOS transistors NMOS1 and NMOS2 may be switched on according to the first mode selection signal SW1 having a high level and may be switched off according to the first mode selection signal SW1 having a low level.

In addition, the third NMOS transistor NMOS3 may be switched off according to the second mode selection signal SW2 having a low level and may be switched on according to the second mode selection signal SW2 having a high level.

FIG. 6 is a diagram showing another implementation of the back EMF amplifying unit according to the embodiment of the present invention.

Referring to FIG. 6, the first and second switches 211 and 213 of the amplification-path circuit part 210 may be made up of first and second transmission gates TMG1 and TMG2, respectively.

In addition, the bypass switch 221 of the bypass-path circuit part 220 may be made up of a third transmission gate TMG3.

The first transmission gate TMG1 may include a first NMOS transistor (NMOS1) to receive the first mode selection signal SW1, and a first PMOS transistor (PMOS1) to receive the second mode selection signal SW2.

The second transmission gate TMG2 may include a second NMOS transistor (NMOS2) to receive the first mode selection signal SW1, and a second PMOS transistor (PMOS2) to receive the second mode selection signal SW2.

The third transmission gate TMG3 may include a third PMOS transistor (PMOS3) to receive the first mode selection signal SW1, and a third NMOS transistor (NMOS3) to receive the second mode selection signal SW2.

The first and second transmission gates TMG1 and TMG2 may be switched on during the initial driving period T1 according to the first mode selection signal SW1 having a high level and the second mode selection signal SW2 having a low level, and may be switched off after the initial driving period T1 according to the first mode selection signal SW1 having a low level and the second mode selection signal SW2 having a high level.

The third transmission gate TMG3 may be switched off during the initial driving period T1 according to the first mode selection signal SW1 having a high level and the second mode selection signal SW2 having a low level, and may be switched on after the initial driving period T1 according to the first mode selection signal SW1 having a low level and the second mode selection signal SW2 having a high level.

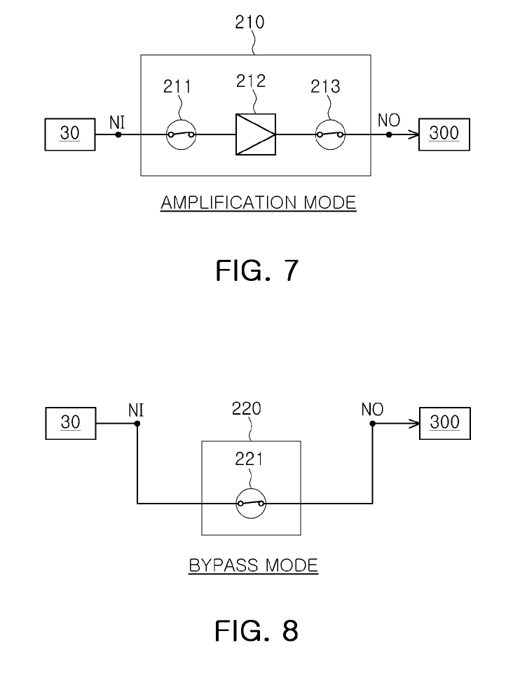

FIG. 7 is a diagram illustrating the operation of the amplification mode according to the embodiment of the present invention.

Referring to FIGS. 1 to 7, since the first and second switches 211 and 213 of the amplification-path circuit part 210 is switched on according to the mode selection signal SW during the initial driving period T1, the back EMF amplifying unit 200 is operated in the amplification mode, such that the amplifier 212 of the amplification-path circuit part 210 becomes operable, to thereby amplify a back EMF voltage form the motor.

FIG. 8 is a diagram illustrating the operation of the bypass mode according to the embodiment of the present invention.

Referring to FIGS. 1 to 8, since the bypass switch 221 of the bypass-path circuit part 220 is switched on according to the mode selection signal SW after the initial driving period T1, the back EMF amplifying unit 200 is operated in the bypass mode, such that the bypass-path circuit part 220 may bypass a back EMF voltage from the motor through the bypass-path.

For example, after the initial driving period T1, the amplitude of the back EMF voltage is sufficiently high to be processed in the zero-crossing detecting unit and thus does not need to be amplified.

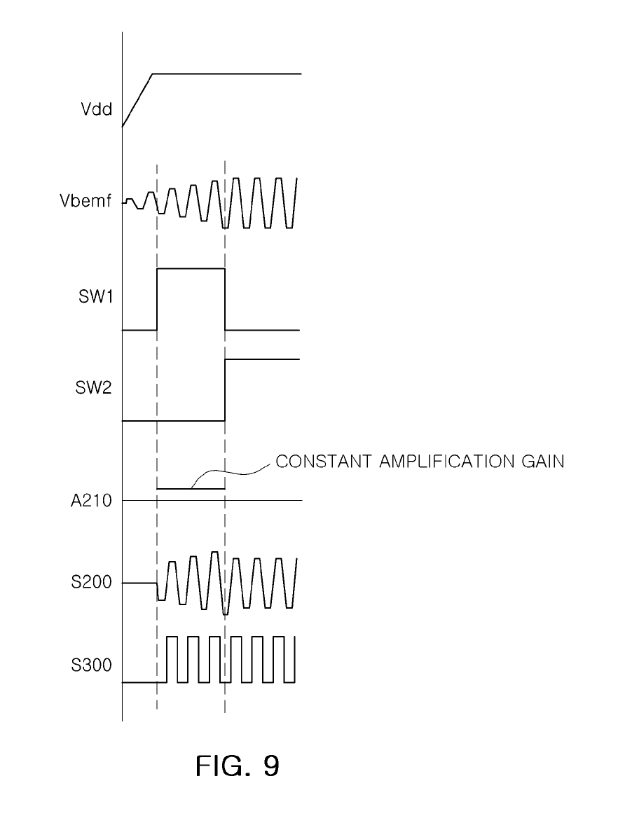

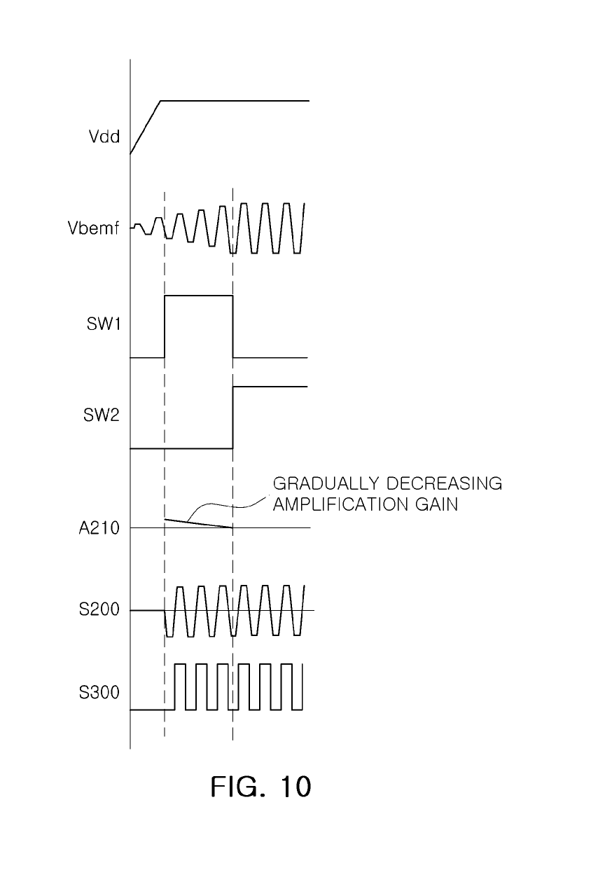

FIG. 9 is a first timing chart of principal voltages and signals according to the embodiment of the present invention. FIG. 10 is a second timing chart of principal voltages and signals according to the embodiment of the present invention.

Referring to FIGS. 1 to 9, the mode selecting unit 100 is supplied with a supply voltage V_{dd} when power is on. At this time, a back EMF voltage V_{bemf} from by the motor 30 also increases gradually.

The first mode selection signal SW1 has a high level during a predetermined initial driving period T1. For example, the first mode selection signal SW1 may be a power on reset (POR) signal for resetting an internal register when power is on.

The second mode selection signal SW2, inverted from the first mode selection signal SW1, has an opposite level to the first mode selection signal SW1.

The signal S200 output from the back EMF amplifying unit 200 has a level, obtained by amplifying the back EMF voltage V_{bemf} with a constant amplification gain, and has the same level with the back EMF voltage V_{bemf} after the initial driving period T1.

Further, the zero-crossing detecting unit 300 may provide the motor control unit 10 with a signal in the form of a pulse which has a high level if the level of the signal S200 output from the back EMF amplifying unit 200 is higher than the reference voltage Vref and has a low level otherwise. The motor control unit 10 may control the operation of the motor based on the signal from the zero-crossing detecting unit 300.

Now, description will be made referring to FIGS. 1 to 10. FIG. 10 is different from FIG. 9 in that the amplifier 212 has a constant amplification gain in FIG. 9 whereas the amplifier 212 has a gradually decreasing amplification gain in FIG. 10.

That is, the back EMF amplifying unit 200 may amplify the back EMF voltage V_{bemf} to a level detectable by the zero-crossing detecting unit 300 or higher by using the gradually decreasing amplification gain during the initial driving period T1.

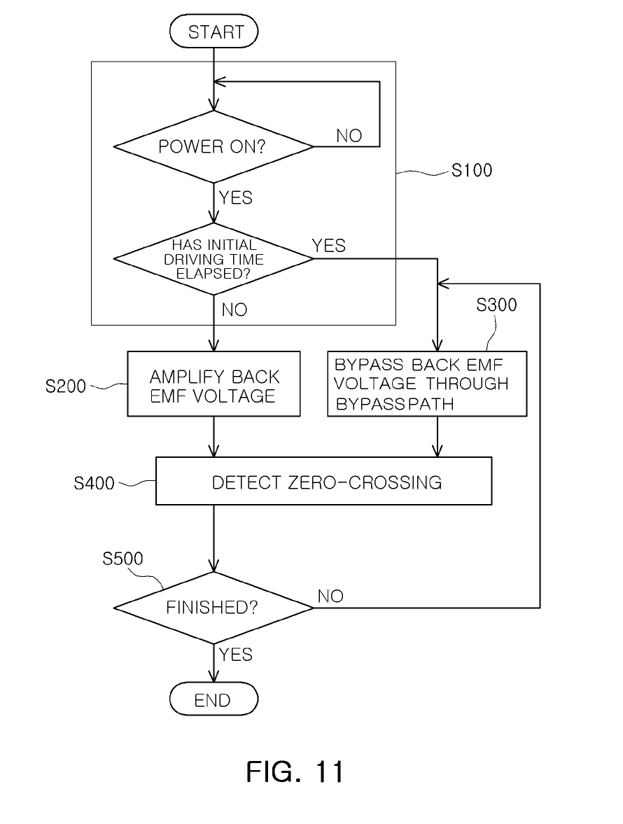

FIG. 11 is a flowchart illustrating a method for detecting back EMF in a sensorless motor according to an embodiment of the present invention.

The method for detecting back EMF in a sensorless motor according to the embodiment of the present invention will be described with reference to FIGS. 1 to 11.

In describing the method for detecting back EMF in a sensorless motor according to the embodiment of the present invention, the above descriptions with reference to FIGS. 1 to 10 are equally applied, and thus the same descriptions will not be repeated.

Firstly, in operation S100, whether the initial driving period T1 has elapsed when power is on is determined by the mode selecting unit 100.

As an example, the mode selecting unit 100 determines whether the initial driving period T1 has elapsed when power is on, such that it may generate the mode selection signal SW having the first mode selection signal SW1 having a high level and the second mode selection signal SW2 having a low level if the initial driving period T1 has not elapsed, and may generate the mode selection signal SW having the first mode selection signal SW1 having a low level and the second mode selection signal SW2 having a high level after the initial driving period T1.

Then, in operation S200, if the initial driving period T1 has not elapsed, the back EMF amplifying unit 200 may amplify a back EMF voltage from the motor according to the first and second selection signals SW1 and SW2.

Here, the back EMF amplifying unit 200 may amplify the back EMF voltage V_{bemf} to a level detectable by the zero-crossing detecting unit 300 or higher.

For example, in operation S200, the amplification-path circuit part 210 of the back EMF amplifying unit 200 may be completed during the initial driving period T1 to amplify a back EMF voltage from the motor.

Incidentally, the back EMF amplifying unit 200 may also amplify the back EMF voltage V_{bemf} to a level detectable by the zero-crossing detecting unit 300 or higher by using the gradually decreasing amplification gain during the initial driving period T1.

Then, in operation S300, if the initial driving period T1 has elapsed, the back EMF amplifying unit 200 may allow a back EMF voltage from the motor to bypass it according to the first and second selection signals SW1 and SW2.

For example, in operation S300, the bypass-path circuit part 220 of the back EMF amplifying unit 200 may be completed after the initial driving period T1 to allow a back EMF voltage from the motor to flow therethrough.

Finally, in operation S400, a zero-crossing of the back EMF voltage, which may have been amplified or have bypassed the amplification-path circuit unit, may be detected.

As above, according to the embodiments of the present invention, back electro-motive force can be accurately detected in a sensorless motor using a back EMF voltage, even during an initial driving period by way of performing an amplification mode in which a back EMF voltage is amplified during the initial driving period, and performing a bypass mode in which a back EMF voltage bypasses an amplification path during a normal mode after the initial driving period.

In particular, the problem relating to a level in a low speed operation at the time of start-up can be simply overcome by way of using a power on reset (POR) signal provided for resetting an internal register when power is on in a POR circuit part, so that a motor can operate stably even at the time of start-up.

While the present invention has been shown and described in connection with the embodiments, it will be apparent to those skilled in the art that modifications and variations can be made without departing from the spirit and scope of the invention as defined by the appended claims.

What is claimed is:

1. An apparatus for detecting back electro-motive force (EMF) in a motor, comprising:
a mode selecting unit selecting between an amplification mode and a bypass mode when power is on;
a back EMF amplifying unit amplifying a back EMF voltage from the motor during an initial driving period if the amplification mode is selected by the mode selecting unit, and allowing the back EMF voltage to bypass it after the initial driving period if the bypass mode is selected by the mode selecting unit; and
a zero-crossing detecting unit detecting a zero-crossing of an output signal from the back EMF amplifying unit,
wherein the back EMF amplifying unit amplifies the back EMF voltage to a level detectable by the zero-crossing unit or higher.

2. The apparatus of claim 1, wherein the back EMF amplifying unit amplifies the back EMF voltages in three phases input through first, second and third output terminals of a three-phase motor or allows them to bypass it.

3. The apparatus of claim 1, wherein the mode selecting unit generates a mode selection signal including a first mode selection signal having a high level during the initial driving period and having a low level after the initial driving period, and a second mode selection signal inverted from the first mode selection signal.

4. The apparatus of claim 1, wherein the mode selecting unit includes:
a mode-selection-signal generating unit generating a first mode selection signal having a high level during the initial driving period and having a low level after the initial driving period, and an inverter inverting the first mode selection signal to provide a second mode selection signal.

5. The apparatus of claim 3, wherein the mode selecting unit includes a power-on-reset (POR) circuit unit generating the first mode selection signal using a POR signal for resetting an internal register when power is on.

6. The apparatus of claim 1, wherein the back EMF amplifying unit includes: an amplification-path circuit part completed during the initial driving period to amplify the back EMF voltage from the motor; and
a amplification-path circuit part completed after the initial driving period to allow the back EMF voltage from the motor to bypass the amplification-path circuit part therethrough.

7. The apparatus of claim 6, wherein the amplification-path circuit part includes at least one switch and an amplifier connected between an input node and an output node of the back EMF amplifier, wherein the at least one switch is switched on during the initial driving period.

8. The apparatus of claim 6, wherein the amplification-path circuit part includes a bypass switch between an input node and an output node of the back EMF amplifier, wherein the bypass switch is switched on after the initial driving period.

9. An apparatus for detecting a back electro-motive force (EMF) in a motor, comprising:
a mode selecting unit providing a mode selection signal for selecting between an amplification mode and a bypass mode when power is on;
a back electro-motive force (EMF) amplifying unit amplifying a back EMF voltage from the motor during an initial driving period, and allowing the back EMF voltage to bypass it after the initial driving period according to the mode selection signal; and
a zero-crossing detecting unit detecting a zero-crossing of an output signal from the back EMF amplifying unit, wherein the back EMF amplifying unit amplifies the back EMF voltage to a level detectable by the zero-crossing unit or higher during the initial driving period with a gradually decreasing amplification gain.

10. The apparatus of claim 9, wherein the mode selection signal includes first and second mode selection signal, and wherein the mode selecting unit includes: a mode-selection-signal generating unit generating the first mode selection signal having a high level during the initial driving period and having a low level after the initial driving period, and an inverter inverting the first mode selection signal to provide the second mode selection signal.

11. The apparatus of claim 10, wherein the mode-selection-signal generating unit includes a power-on-reset (POR) circuit unit generating a POR signal for resetting an internal register using the first mode selection signal when power is on.

12. The apparatus of claim 9, wherein the back EMF amplifying unit includes: an amplification-path circuit part completed during the initial driving period to amplify the back EMF voltage from the motor; and
a amplification-path circuit part completed after the initial driving period to allow the back EMF voltage from the motor to bypass the amplification-path circuit part therethrough.

13. The apparatus of claim 12, wherein the amplification-path circuit part includes at least one switch and an amplifier connected between an input node and an output node of the back EMF amplifier, wherein the at least one switch is switched on during the initial driving period.

14. The apparatus of claim 12, wherein the amplification-path circuit part includes a bypass switch between an input node and an output node of the back EMF amplifier, wherein the bypass switch is switched on after the initial driving period.

15. An apparatus for detecting back electro-motive force (EMF) in a motor, comprising:
a mode selecting unit providing a mode selection signal including a first mode selection signal having a high level during an initial driving period and having a low level after the initial driving period, and a second mode selection signal inverted from the first mode selection signal;
a back EMF amplifying unit amplifying a back EMF voltage from the motor during the initial driving period according to the first and second mode selection signals, and allowing the back EMF voltage to bypass it after the initial driving period according to the first and second mode selection signals; and
a zero-crossing detecting unit detecting a zero-crossing of an output signal from the back EMF amplifying unit, wherein the mode selecting unit generates the first mode selection signal using a power-on-reset (POR) signal for resetting an internal register when power is on and wherein the back EMF amplifying unit amplifies the back EMF voltage to a level detectable by the zero-crossing unit or higher.

16. The apparatus of claim 14, wherein the back EMF amplifying unit includes: an amplification-path circuit part completed during the initial driving period to amplify the back EMF voltage from the motor; and
a amplification-path circuit part completed after the initial driving period to allow the back EMF voltage from the motor to bypass the amplification-path circuit part therethrough.

17. The apparatus of claim 16, wherein the amplification-path circuit part includes at least one switch and an amplifier connected between an input node and an output node of the back EMF amplifier, wherein the at least one switch is switched on during the initial driving period.

18. The apparatus of claim 16, wherein the amplification-path circuit part includes a bypass switch between an input node and an output node of the back EMF amplifier, wherein the bypass switch is switched on after the initial driving period.

19. A method for detecting back electro-motive force (EMF) in a motor, comprising:
determining, by a mode selecting unit, whether an initial driving period has elapsed when power is on;
amplifying, by a back EMF amplifying unit, a back EMF voltage from the motor if it is determined that the initial driving period has not elapsed;
allowing, by the back EMF amplifying unit, the back EMF voltage to bypass it if it is determined that the initial driving period has elapsed; and
detecting a zero-crossing of the amplified EMF voltage or the bypassing EMF voltage, wherein the back EMF amplifying unit amplifies the back EMF voltage to a level detectable by a zero-crossing detecting unit or higher.

20. The method of claim 19, wherein the amplifying of the back EMF voltage includes amplifying the back EMF voltage from the motor by an amplification-path circuit part of the back EMF amplifying unit, the amplification-path circuit part being completed during the initial driving period.

21. The method of claim 19, wherein the allowing of the back EMF voltage to bypass includes allowing the back EMF voltage from the motor to bypass it through a amplification-path circuit part of the back EMF amplifying unit, the amplification-path circuit part being completed after the initial driving period.

22. A method for detecting back electro-motive force (EMF) in a motor, comprising:
determining, by a mode selecting unit, whether an initial driving period has elapsed when power is on, to thereby generate a mode selection signal including a first mode selection signal having a high level and a second mode selection signal having a low level if the initial driving period has not elapsed, and to generate the mode selection signal having the first mode selection signal having a low level and the second mode selection signal having a high level after the initial driving period;
amplifying, by a back EMF amplifying unit, a back EMF voltage from the motor according to the first and second mode selection signals if it is determined that the initial driving period has not elapsed;
allowing, by the back EMF amplifying unit, the back EMF voltage to bypass it according to the first and second mode selection signals if it is determined that the initial driving period has elapsed; and
detecting a zero-crossing of the amplified EMF voltage or the bypassing EMF voltage, wherein the back EMF amplifying unit amplifies the EMF voltage to a level detectable by a zero-crossing detecting unit or higher during the initial driving period with a gradually decreasing amplification gain.

23. The method of claim 22, wherein the amplifying of the back EMF voltage includes amplifying the back EMF voltage from the motor by an amplification-path circuit part of the back EMF amplifying unit, the amplification-path circuit part being completed during the initial driving period.

24. The method of claim 22, wherein the allowing of the back EMF voltage to bypass includes allowing the back EMF voltage from the motor to bypass it through a amplification-path circuit part of the back EMF amplifying unit, the amplification-path circuit part being completed after the initial driving period.
